(19) United States
(12) Patent Application Publication
(10) Pub. No.: US 2026/0016396 A1
(43) Pub. Date: Jan. 15, 2026

(54) INLINE LIGHT DETECTION SYSTEM FOR NANOPARTICLE ANALYSIS

(71) Applicant: Wyatt Technology, LLC, Goleta, CA (US)

(72) Inventors: Daniel I. Some, Atlit (IL); Steven P. Trainoff, Santa Barbara, CA (US)

(21) Appl. No.: 19/263,623

(22) Filed: Jul. 9, 2025

Related U.S. Application Data
(60) Provisional application No. 63/669,044, filed on Jul. 9, 2024.

(51) Int. Cl. G01N 15/1434; G01N 15/14

(52) U.S. Cl. CPC G01N 15/1436; G01N 15/1459

(57) ABSTRACT

An apparatus comprises a light source; a spherical flow cell having a bore for providing a flow path for a fluid sample and for transmitting light from the light source through the fluid sample in the bore, the bore extending from an input port to a first output port of the spherical flow cell, and for capturing a scattered portion of the light for output through a second output port; a first detector proximal to the first output port for measuring a transmitted light intensity of the light; a second detector proximal to the second output port for measuring a scattered intensity of the light; and a special purpose computer processor that calculates a true absorption value from the measured transmitted light intensity and the measured scattered intensity.

### RELATED APPLICATIONS

This application claims priority to U.S. provisional patent application No. 63/669,044 filed Jul. 9, 2024 and titled “Inline Light Detection System for Nanoparticle Analysis,” the contents of which are incorporated by reference in their entirety.

### FIELD

The present disclosure relates to light scattering instruments, and more specifically, to inline UV-Vis detection system for accurate absorption and scattering characterization of nanoparticles.

### BACKGROUND

The present disclosure relates to ultraviolet (UV)—visible (Vis) spectroscopy systems for distinguishing and measuring scattering and absorption for nanoparticles.

UV-Vis spectroscopy is a well-known analytical technique that measures the amount of light that is absorbed by or transmitted through a sample in comparison to a reference sample, at one or more discrete UV and/or visible wavelengths. While it is common to use UV-Vis spectroscopy to quantify the concentrations of biologics such as proteins or DNA via absorption, conventional analytical techniques are not suitable for larger gene vectors such as lipid nanoparticles (LNP)-ribonucleic acid (RNA) or lentiviruses, exosomes, AAV aggregates, multi-MDa vaccine glycoconjugates, or drug-delivery nanoparticles. This is because the UV-Vis detectors characterize analytes by measuring, and quantifying, UV-Vis extinction, which is a combination of scattering and absorption. For molecules that are smaller than about 1/10th the wavelength of light, e.g., less than 30-40 nm, the scattered portion is smaller than the absorbed portion, and the extinction measured by the UV-Vis detector may be used for concentration calculations. However, when measuring larger nanoparticle, e.g., greater than 40 nm, one cannot assume that the extinction signal pertains only to absorption because the scattered portion exceeds the absorbed portion and is therefore relevant, and may cause measurement errors if not factored into calculations of the molecular concentration in the nanoparticles. A device which can quantify both extinction and scattering and combine these two quantities in order to calculate true absorption by the sample, would fulfill the need for quantifying the concentrations of the constituent materials of nanoparticles such as those mentioned above.

The ability to disentangle the effects of absorption from scattering from the forward extinction is based on the observation that absorption, unlike scattering, has no angular dependence. The extinction measured by the forward detector contains all of the absorption signal, but only part of the scattering. What is needed is a measure of how much of the scattering signal appears in the forward detector and how much is distributed over the full solid angle of the system. The well-known optical theorem, attributed to Werner Heisenberg and earlier derived by Wolfgang Sellmeier and Lord Rayleigh, provides a resolution. It relates the total scattering cross section σₜₒₜ to the forward scattering amplitude f(0) via the relation

$${σ}_{tot} = \frac{4 π}{k} Im f ( 0 ) ,$$

In the context of the current problem, the full scattering signal σₜₒₜ can be measured by enclosing the measurement sample in an integrating sphere. The integrating sphere provides a measurement of σ_tot which can then be used to correct the forward extinction measurement to determine how much is due to absorption, and how much is due to scattering. It is worth noting that the derivation of the optical theorem is based on conservation of energy so the correction based on measuring σₜₒₜ, can be universally applied to all samples without a per-sample calibration.

### SUMMARY

In one aspect, an apparatus comprises a light source providing light; a flow cell having a bore for providing a flow path for a fluid sample and for transmitting the light from the light source through the fluid sample in the bore, the bore extending from an input port to a first output port of the flow cell, and for capturing a scattered portion of the light for output through a second output port; a first detector proximal to the first output port for measuring a transmitted light intensity of the source of light; a second detector proximal to the second output port for measuring a scattered intensity of the source of light; and a special purpose computer processor that calculates a true absorption value from the measured transmitted light intensity and the measured scattered intensity.

Additionally or alternatively, the flow cell is a spherical flow cell or integrating sphere that has a solid interior and includes a diffuser coating about a spherical surface of the flow cell, and wherein the first and second output ports extend through the diffuser coating so that at least the scattered portion can exit the spherical flow cell.

Additionally or alternatively, the flow cell is a spherical flow cell or integrating sphere that has a hollow interior and includes a diffuser coating about a spherical surface of the flow cell, and further includes a tubular element extending through the hollow interior for providing the flow path for the fluid sample and the light.

Additionally or alternatively, the second detector includes a scattered light detector optically coupled to an opening in the diffuser coating at the second output port to detect the scattered portion of the light, and for distinguishing the scattered portion of the light from an absorbed portion of the transmitted light intensity in order to determine a true absorption value.

Additionally or alternatively, the special purpose computer processor calculates a molecular concentration of analytes referred to as nanoparticles of the fluid sample from the true absorption value.

Additionally or alternatively, the nanoparticles are greater than 40 nm.

Additionally or alternatively, the nanoparticles have a dimension greater than one tenth of the wavelength of the source of light.

Additionally or alternatively, the sample material is part of a solution that includes a formulation of lipid nanoparticles (LNPs) encapsulating ribonucleic acid (RNA).

Additionally or alternatively, the apparatus further comprises an inlet window adjacent the fluid inlet, and an outlet window adjacent the first fluid outlet for providing an optical path through the bore for the transmitted light intensity, wherein the inlet window is optically coupled to a light source, and wherein the outlet window is optically coupled to the first detector.

Additionally or alternatively, one or more wavelength-selective dispersion gratings to provide two or more input wavelengths of light from the light source prior to an array of photodiodes for transmission and scattering.

Additionally or alternatively, a center of the flow cell is at an intersection of a first axis and a second axis perpendicular to the first axis, where the flow path extends along the first axis, and the second detector is offset from the second axis.

In another aspect, an apparatus comprises an optically transparent sphere (e.g., solid glass sphere or empty glass sphere) wherein an outer surface of the sphere comprises a diffuser coating to reflect scattered light in multiple directions; a bore through an axis of the sphere to allow for the flow of an analyte, wherein the bore is coupled to a fluid inlet, to a fluid outlet, to an inlet window adjacent to the fluid inlet, and to an outlet window adjacent to the fluid outlet, wherein the inlet window is optically coupled to a light source, and wherein the outlet window is optically coupled to a transmission detector. The apparatus further comprises an opening in the diffuser coating and in a flow cell holder housing the sphere, wherein the opening allows for the scattered light to exit the sphere; and a scattering detector optically coupled to the opening in the diffuse coating to detect the scattered light, allowing for calculating absorption by the analyte (see new calculation formula).

In another aspect, a computer implemented method comprises providing, by a flow cell, a fluid path for fluid sample constituents; transmitting light from a source of light through the fluid sample constituents in the fluid path from an input port to a first output port of the flow cell; capturing, by the flow cell, a scattered portion of the light for output through a second output port of the flow cell; measuring, by a first detector, a transmitted light intensity of the source of light; measuring, by a second detector, a scattered intensity of the source of light; and calculating, by a computer system, a true absorption value from the measured light intensity and the measured scattered intensity.

### BRIEF DESCRIPTION OF THE DRAWINGS

FIG. 1 is a diagram of an inline UV-Vis detection system, in accordance with some embodiments.

FIG. 1A is a diagram of an inline UV-Vis detection system, in accordance with other embodiments.

FIG. 2 is a schematic diagram of an embodiment of a nanoparticle characterization system equipped with a UV-Vis detection system.

FIG. 3 is a schematic diagram of an embodiment of another nanoparticle characterization system equipped with a UV-Vis detection system.

FIG. 4 is a schematic diagram of an embodiment of another nanoparticle characterization system equipped with the UV-VIS detection system of FIG. 1.

FIG. 5 is a flow diagram of an embodiment of a method for measurements of a sample.

FIG. 6 depicts a computer system in accordance with some embodiments.

### DETAILED DESCRIPTION

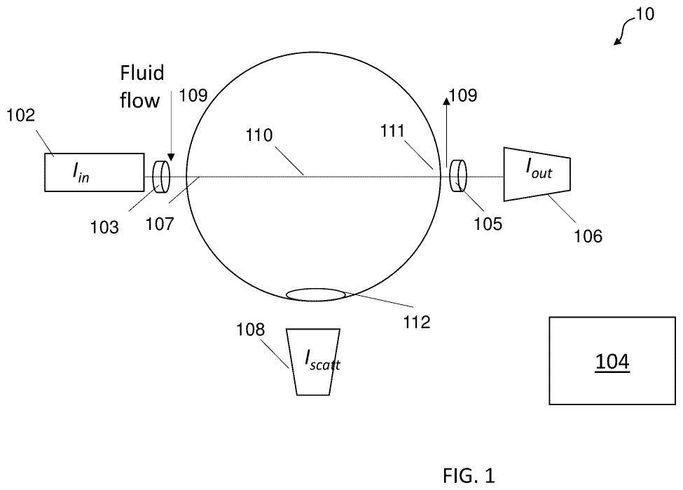

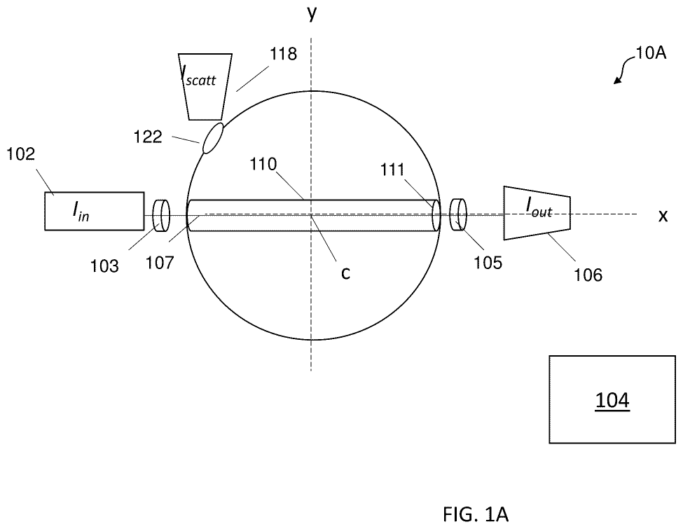

FIG. 1 is a block diagram of an inline UV/Vis detection system 10, in accordance with some embodiments. The UV/Vis detection system 10 may be configured as a spectrophotometer or related instrument, and used with a payload analysis system described in some applications below, but not limited thereto. The detection system 10 can be used for quantifying larger gene vectors and their molecular components such as LNP-RNA, lentivirus, exosomes, liposomes, AAV aggregates, multi-MDa vaccine glycoconjugates and drug-delivery nanoparticles.

The detection system 10 includes a light source 102 that emits light across one or more wavelengths. In particular, the light source 102 emits visible and/or UV light in a particular wavelength range. In some embodiments, the light source 102 is a single light source, for example, a light-emitting diode (LED), laser diode, lamp, or other light source. In some embodiments, the light source 102 includes a first light source for scanning UV wavelengths and a second light source for scanning visible wavelengths. A switching mechanism (not shown) can be provided to switch between the two light sources during a measurement. In other embodiments, a finite number of light sources are provided, for example, two light sources such as LEDs, each constructed to emit light at a single wavelength, with a switching mechanism so that the light sources can serve alternately for illumination.

The detection system 10 includes an integrating sphere constructed and arranged as a flow cell 104, for example, a flow cell 104 having an optically transparent spherical shape or other three-dimensional shape such as an ellipsoidal flow cell. In some embodiments, the flow cell 104 has a plurality of input and output ports, described below. In some embodiments, the spherical flow cell 104 is formed of a solid material such as glass and includes a bore 110 extending through a center diameter of the flow cell 104. In some embodiments, a diffuser coating material is applied to the external surface of the spherical flow cell 104. The bore 110 extends from an input port 107 to a first output port 111 of the spherical flow cell. The spherical flow cell 104 can also have a second output port 122 where scattered light can exit. The first output port 111 may receive a combination of sample fluid and light transmitted through the sample fluid. The second output port, on the other hand, is constructed and arranged to allow only scattered light to exit to flow cell 104.

In other embodiments, the integrating sphere of the spherical flow cell 104 is hollow and contains an optically transparent tubular element 110 through the hollow sphere 104, or a substantially spherical cavity covered with a diffuse reflective coating. Here, the hollow integrating sphere 104 and the tubular element 110 can be formed of a same material such as glass or the like, or may be formed of different materials. Here, the spherical flow cell 104 has a spherical-shaped inner surface and inner wall formed of a light scattering material.

The inward-facing surface of the integrating sphere 104 may be coated with a diffuser coating material that provides low absorbance and high reflectance for light measurements such that light beams impinging on the internal surface are reflected diffusely from the coating and thus illuminate the sphere uniformly. Hence light scattered by the sample fluid is made spatially uniform by the sphere and the scattering detector 108 measures an intensity that is independent of the initial spatial dependence of the sample fluid's scattering profile.

The input port 107 and first and second output ports 111, 122 extend through the diffuser coating for entering and exiting the flow cell 104, respectively. In some embodiments, the spherical flow cell 104 includes a manifold or related transition apparatus between the input port 107 of the bore 110 and the first output port 111 of the bore 110. The light source 102 is positioned at one end of the bore 110. A transmission detector 106 is at an opposite end of the bore 110 for converting the received light from the flow cell 110 into an electronic signal readable by a computer 140. The transmission detector 106 can be at the first output port 111. A first window 103 or the like may be positioned between the light source 102 and the input end of the bore 110. A second window 105 or the like may be positioned between the output end of the bore 110 and the transmission detector 106. The windows 102, 105 may include apertures or optically transparent windows for allowing light emitted by light source 102 and traveling along a light path to enter and exit the flow cell 104. One or more capillaries 109 may communicate with the bore 110 operating as a flow cell to flow a sample through a sample path between the capillaries at the input and output of the bore 110. In some embodiments, the sample flow via the capillaries 109 perpendicular to the bore 110 flows from the input port 107 through the length of the bore 110 to the first output port 112. Here, the windows 103 and 105 can seal the flow path while providing optical access for the light. In other embodiments, the flow path may include a different input port and output port than the input port 107 and the first output port 112 through which light from the light source 102 travels. In other embodiments, the capillaries 109 are not perpendicular to the bore 110, but instead are constructed and arranged so that fluid flows towards the surface of the window 103 to wash the window surface and mitigate the presence of contamination.

The detection system 10 is constructed and arranged to measure discrete wavelengths of UV and/or visible light, and/or wavelengths in other spectra of electromagnetic radiation. These discrete wavelengths of light are absorbed by or transmitted through a sample at the spherical flow cell 104. The sample material may both absorb and scatter the light passing through it. The transmission detector 106 at an opposite end of the bore 110 includes a transmission photodiode, semiconductor, or the like for measuring the light intensity (Iₒᵤₜ) related to emission spectra of a source of light transmitted by the light source 102. More specifically, due to absorption and scattering in the flow cell 104 the transmission detector 106 can measure a total extinction of the light in the visible and/or UV spectrum. The scattering detector 108 is located at the second output port 112, or hole, aperture, or opening in the spherical flow cell 104 where light, scattered after the sample having scattering properties in the bore 110 is irradiated, can exit for converting scattered light from the flow cell 110 into an electronic signal readable by the computer 140. In some embodiments, as shown in FIG. 1, the scattering detector 108 and second output port 112 are positioned along a vertical (y) axis at a center of the integrating sphere. In other embodiments, as shown in FIG. 1A, a detection system 10A includes a scattering detector 118 and collection port 122 that are off-axis. More specifically, a center (c) of the spherical flow cell is at an intersection of a first axis (x), e.g. a horizontal axis and a second axis (y), e.g., a vertical axis, perpendicular to the first axis (x). The bore 110 and flow path extend along the horizontal axis (x). Here, the scattering detector 118 is offset from the vertical axis (y), which may permit an improved homogenization of the scattering signal. The scattering detector 108 can include a second photodiode, semiconductor, or the like for measuring the scattered light (I_{scatt}) of the source of light transmitted by the light source 102. Thus, both the transmitted light intensity component and scattered component of light passing through a sample in the flow cell 110 are measured, namely, by the detectors 106, 108, respectively.

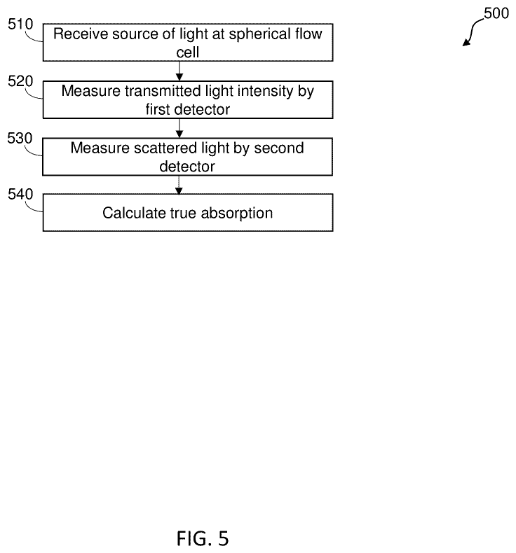

The computer 140 can quantify a total absorption from the total extinction measured by the transmission detector 106 and the total scattering measured by the scattering detector 108, or 118. In some embodiments, the computer 140 can determine an absorption value, e.g., calculated according to the method 500 in FIG. 5, and use this value to calculate a molecular concentration in the nanoparticles of a sample, since molecular concentration can be derived from the quantified true absorption, the absorption path length and the molecular absorption coefficient. The computer 140 can execute an algorithm, for example, described below, provided as program code stored at and executed by the computer 140 to use scattering intensity combined with absorption data to assess whether a sample of interest is a particle or free macromolecule or the like, since macromolecules will scatter very little relative to the absorbed intensity while nanoparticles will scatter much more relative to the absorbed intensity. The computer 140 can generate for an input/output device such as a display screen or other computer one or more graphs or other forms of information that are presented as absorbance spectrum, transmittance as function of wavelength, molecular concentration results, and so on.

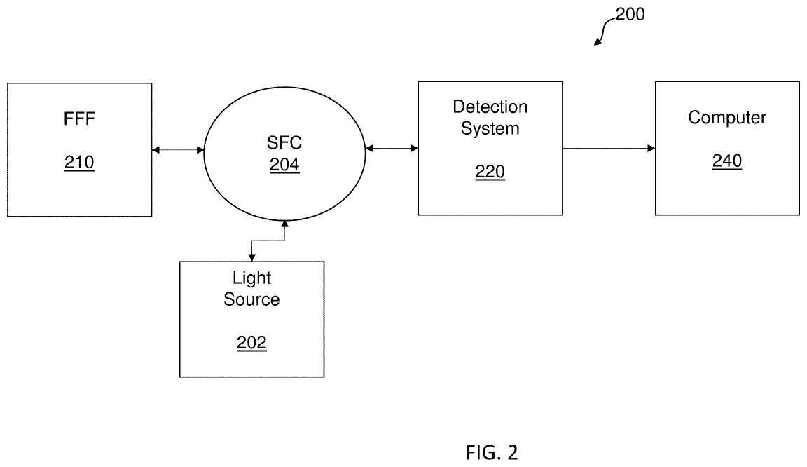

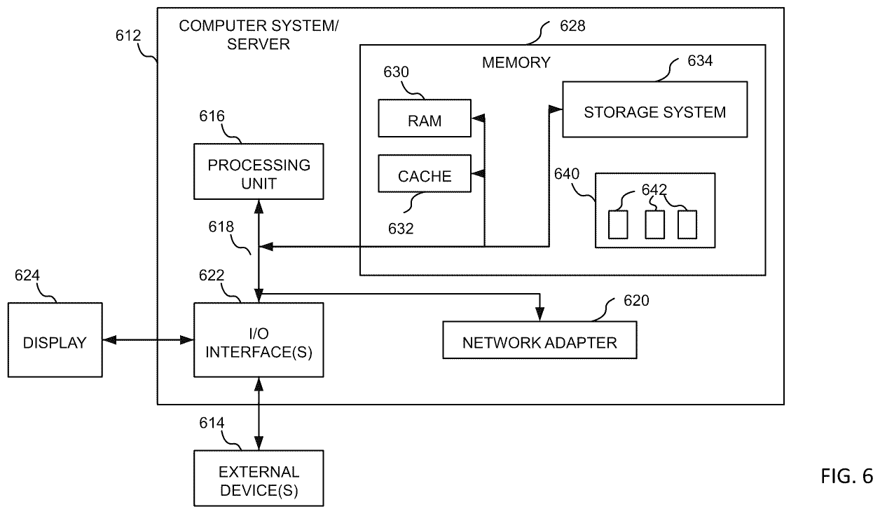

FIG. 2 is a schematic diagram of an embodiment of a nanoparticle characterization system 200 equipped with an inline UV/Vis detection system 220 similar to or the same as the detection system 10 of FIG. 1, and more specifically, includes a spherical flow cell (SFC) 204 similar to or the same as the flow cell 104 of FIG. 1. Accordingly, the nanoparticle characterization system 200 can be used to measure particle size distributions of samples and determine size-dependent payload or the encapsulation efficiency of nanoparticle drugs. For example, the nanoparticle characterization system 200 can be used with analytical tools for quantifying larger gene vectors, drug delivery nanoparticles, extracellular vesicles, large aggregates or the like, for example, microfluidic formulations of RNA in lipid nanoparticles shown in FIG. 6. In some embodiments, as shown in FIG. 2, the UV/Vis detection system 220 and flow cell 204 are in line with respect to a field flow fractionator (FFF) apparatus 210 or other separation system. The nanoparticles can then travel through the MALS detector 330 downstream from the UV detector 320, which measures the light scattering with respect to the source of light applied to the sample to determine a molecular weight

In particular, the FFF apparatus 210 may include a flow controller and separation channel to separate analytes extracted from a sample, namely, macromolecules and nanoparticles, according to size or other property, and provide the separated analytes to the detection system 220, which may include a UV/Vis detector, MALS/DLS detector, and/or RI detector.

The detection system 220 can be used to determine the properties in each fraction output from the FFF apparatus 210. The results can be used to calculate a molecular concentration of the nanoparticle constituent materials and/or other payload analysis. For example, the detection system 220 includes a combination of FFF, MALS, UV/Vis, and/or RI instruments to perform payload analysis for viral vector titers and the like. For example, particle size and concentration can be derived from the scattered intensity (Iscatt) from a MALS detector while the payload and encapsulating molecule concentrations are determined from the UV/Vis detector alone or in combination with an RI detector.

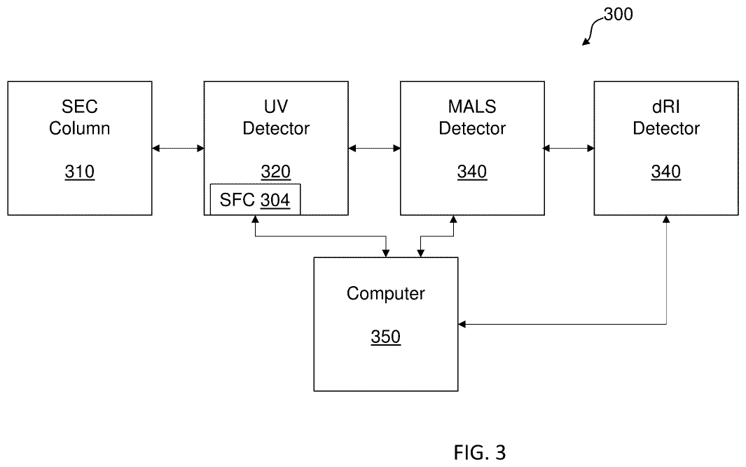

FIG. 3 is a schematic diagram of an embodiment of a nanoparticle characterization system 300, e.g., an HPLC/FPLC system, for performing a size exclusion chromatography—multi-angle light scattering (SEC-MALS) operation for characterizing a sample of interest. As shown, the system 300 may include a separation system, namely, a SEC column 310, a UV/Vis detector 320, a MALS detector 330 and a dRI detector 340. The UV/Vis detector 320 may include a spherical flow cell 304 similar to or the same as the flow cell 104 of FIG. 1 or flow cell 204 of FIG. 2.

During operation, a sample is run through the SEC system, including the SEC column 310 to separate the constituents of a sample mixture carried by a mobile phase through the column 310 according to size or the like. The separated nanoparticles then pass through the UV/Vis detector 320, which uses transmission and scattering detectors (see FIG. 1) to measure the transmitted UV/Vis light intensity and scattered light, respectively, for determining the true absorption and in doing so provides concentration data based on the level of absorption of ultraviolet and visible radiation in the separated nanoparticles.

The nanoparticles can then travel through the MALS detector 330 downstream from the UV/Vis detector 320, which measures the light scattering with respect to the source of light applied to the sample to determine a molecular weight and size. The sample can then pass through the differential refractive index (dRI) detector 340, which can measure the change in refractive index of the sample solution to a blank solvent to determine an accurate concentration of macromolecules or nanoparticles. The output of one or more of the detectors 320, 330, 340 can be provided to a computer 350, which can generate a chromatogram or other analysis results.

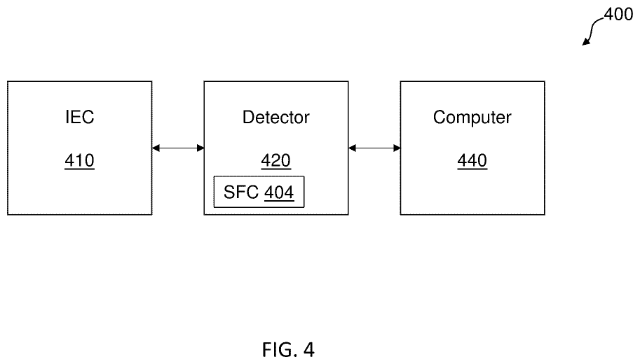

FIG. 4 is a schematic diagram of an embodiment of another nanoparticle characterization system 400. The characterization system 400 includes an ion exchange chromatography (IEC) system 410 having an ion exchange column separation device 410 coupled to a detector 420. A sample can be loaded into the column separation device 410, for example, an anion-exchange column, and detected with multi-angle light scattering and UV/Vis detectors prior to data analysis using the computer 440. The detector 420 may include a spherical flow cell 404 similar to or the same as the flow cell 104 of FIG. 1, flow cell 204 of FIG. 2, or the flow cell 204 of FIG. 3. The absorption determined from the flow cell 404 may be used to determine a concentration of molecules that absorb ultraviolet or visible light. The detector 420 may include a UV/Vis detector and/or a MALS detector, but not limited thereto. In other embodiments, the detector 420 may be implemented as part of a system that performs ultrafiltration/diafiltration (UF/DF), and the like. Therefore, other detectors may equally apply. The IEC-based system 400 can be used to provide a detailed assessment of the biophysical properties of larger gene vectors in heterogenous samples, or other analysis of nanoparticles and a variety of preparative unit operations.

FIG. 5 is a flow diagram of an embodiment of a method 500 for measurement of a sample. In some embodiments, the steps in the method 500 can be performed by elements of a characterization system described in FIGS. 1-4.

At block 510, an integrating sphere operating as a flow cell receives a source of visible and/or UV light (Iᵢₙ) from a light source. A material sample is positioned in the spherical flow cell. Both scattering and absorption occur at the material sample.

At block 520, the transmitted light intensity (Iₒᵤₜ) is measured by a first detector.

At block 530, the scattered light intensity (I_{scatt}) captured by the integrating sphere is measured by a second detector.

At block 540, a computer processor of the instrument electronics, e.g., computer 140, can determine a true absorption according to equation (1):

$$Abs = - log ( \frac{{I}_{out}}{{I}_{i n} - c * {I}_{scatt}} ) \qquad ( 1 )$$

Here, c is a calibration factor. Each integrating sphere has a specific and unique throughput and configuration. In addition, physical features of the integrating sphere may result in a loss in light reflection, the escape of light through the apertures, and so on. For example, changes in the reflectance of the sphere coating can result in effects on throughput. The calibration factor c takes this into account with respect to differing geometry and light levels between calibration and use that may have an effect on the sphere system, or reabsorption of light through the flow path of the bore.

It is well known that in the absence of scattering the intensity of transmitted light is quantitatively related to the amount of light absorbed by the sample, and that the absorbance is equal to the fraction involving the natural logarithm of the intensity of light before passing through the sample (Iᵢₙ) divided by the intensity of light after passing through the sample (Iₒᵤₜ). However, equation (1) considers the true absorption where the measured total scattering value is subtracted from the measured total incident intensity value. The system provides for sufficient sensitivity to accomplish the foregoing.

By way of example, the method 500 can be applied to an LNP-RNA. An inline measurement apparatus such as a UV-Vis detection system in accordance with embodiments herein can be implemented to analyze an LNP-RNA, which has a size comparable to the wavelength of UV light, and measure the concentration of the payload. When an RNA payload is provided with the LNP, the payload is prone to absorption while the LNP is prone to scattering. Notably, an empty LNP (i.e., containing no RNA) has no UV absorption but can produce a UV extinction signal due to scattering of incident UV light. A conventional inline measurement apparatus may measure extinction alone, which would suggest the presence of a payload even though the LNP is empty. Hence a conventional inline UV measurement apparatus is insufficient to quantify the payload.

The UV-Vis detection system 10 solves this problem by inherently distinguishing the scattering component from the absorption component. When the UV-Vis detection system 10 is applied in accordance with embodiments herein, the detection system 10 discriminates the scattering component (I_{scatt}) from the absorption component (I_{abs}) to analyze the LNP-RNA payload, allowing for the measurement of RNA in the loaded LNP and similarly determining a concentration of payload component materials in other nanoparticles.

It is well-known that the wavelength-dependent absorption of analytes is used for measuring concentration. As described above, the embodiments of the present inventive concept can operate with analytes having molecules or particles comparable to or larger than the wavelength of light. In a single-absorber particle such as LNP-RNA or protein-polysaccharide conjugates, one wavelength is sufficient to determine total encapsulated payload. In a multi-absorber particle such as a viral vector, more than one wavelength is needed. Multiple wavelength correction may be performed in several ways. In some embodiments, temporal multiplexing is performed to measure different input wavelengths at different times. In other embodiments, two or more input wavelengths may be generated by the light source with a corresponding number of wavelength-selective photodiodes (e.g., each is filtered for one of the input wavelengths) both for transmission and scattering, and each photodiode is for each discrete wavelength. In other embodiments, referring again to FIG. 1, one or more wavelength-selective dispersion gratings (not shown) can be for each detector 106, 108 to provide two or more input wavelengths of light from the light source prior to an array of photodiodes for transmission and scattering. In particular, spatial multiplexing can be performed where all wavelengths are transmitted through the integrating sphere and the gratings are at the outputs of the sphere to direct specific wavelengths to predetermined photodiodes. A beamsplitter or the like can be positioned near the sphere aperture or output port 111, 112 for providing the discrete wavelength to each corresponding photodiode.

In some embodiments, following the calculation of absorption at block 540, an additional correction step may be applied to compensate for secondary absorption, which may influence the measured scattering intensity I_{scatt}. Specifically, a portion of the scattered light may be reabsorbed by the sample before reaching the scattering detector, resulting in an underestimation of the true scattered signal and, therefore, a deviation in the calculated absorption.

Two primary pathways may contribute to secondary absorption: prior to exiting the bore 110 and after exiting the bore 110.

Prior to exiting the bore 110, light is scattered in different directions. Scattered light may be reabsorbed while still within the sample volume in the bore 110. The path length for this secondary absorption depends on the direction of scattering. Light scattered perpendicular to the bore axis traverses, on average, a distance equivalent to half the bore diameter, offering an opportunity for absorption along that trajectory. Light scattered nearly parallel to the bore axis sees a path through the sample approximating half the bore length, with an absorption probability roughly (1/√2) that of the primary absorption due to the angular path. Reducing the bore diameter can help mitigate the risk of secondary absorption for perpendicularly scattered light. However, reducing the bore length to suppress absorption along axial paths may compromise the absorption path length critical for primary detection. Therefore, care should be taken to avoid reducing bore length excessively to preserve sensitivity for primary absorption.

In the second approach after exiting the bore 110, the light is diffused by the integrating sphere 104 to fill the entire volume. The probability of secondary absorption depends on the average number of internal reflections before exiting the sphere via the scattering detector port. This probability is related to the sphere's M-factor:

$$M = \frac{ρ}{1 - ρ ( 1 - f )}$$

where ρ is the reflectance of the diffusive surface and f is the port fraction, i.e. the relative total surface area of the open ports relative to the total sphere surface area. The probability of secondary absorption of scattered light that has exited the bore 110 can be reduced by reducing the M-factor, e.g. by reducing the reflectance or by increasing the port fraction. For example, the reflectance should be less than 95% and the port fraction larger than 5%, which can result in a greater than 3× reduction in the M-factor compared to 98% reflectance and 1% port fraction.

The probability of secondary absorption may depend on the bore volume ratio, i.e., the ratio of the volume of the bore 110 relative to that of the sphere. Probability of secondary absorption of scattered light that has exited the bore 110 can be reduced by reducing the bore volume ratio, by reducing the diameter of the bore 110 relative to the diameter of the sphere 104. For example, the bore diameter should be less than 10% of the sphere diameter.

In some embodiments, additional calibration steps are included to ensure high-fidelity measurements. In particular, prior to sample analysis, a baseline measurement is determined using pure solvent or buffer and there are no nanoparticles in the flow cell. The incident light intensity (Iin) can be determined by measuring the transmitted light intensity (Iout), or the amount of light that successfully passes through the sample in the flow cell and reaches the transmission detector when the flow cell contains only pure solvent or buffer (i.e., no nanoparticles). Thus, the baseline value measurement of the transmitted intensity is Iout(0). This ensures that absorption is measured relative to a reference state without scattering or additional extinction from analytes.

Similarly, a baseline value for scattered intensity, I_{scatt}(0), is recorded under the same baseline solvent conditions. This scattered-light baseline (I_{scatt}(0)) enables correction for background scattering from the system, tubing, or solvent. I_{scatt}(0) can be subtracted from subsequent measured values of I_{scatt}.

These two baseline values Iout(0), I_{scatt}(0) are important for the calibration for accurate absorption measurements. In equation (2), the baseline values reduce to equation (1) when I_{scatt}(0)=0, and reduces the absorption value=−log(1)=0 when both measured values equal the baseline values.

$$Abs = - log ( \frac{{I}_{out}}{{I}_{out} ( 0 ) - c * ( {I}_{scatt} - {I}_{scatt} ( 0 )} ) \qquad ( 2 )$$

In other words, this formulation yields zero absorption when both Iₒᵤₜ and I_{scatt} equal their respective baselines. This correction improves quantitative accuracy, particularly for applications sensitive to minor scattering or where instrument baselines are non-negligible.

Although the above may help alleviate secondary absorption, it may not be entirely eliminated. The effect of secondary absorption on the measurement may be further calibrated by measuring a series of particles of different sizes that both absorb and scatter the incident light.

FIG. 6 depicts a computer system 600 in accordance with an exemplary embodiment. In an exemplary embodiment, the computer system 600 is a standalone computer system, a network of distributed computers, or a cloud computing node server. In some embodiments, the computer system 600 can perform some or all of the method 400 of FIG. 4 and/or method 500 of FIG. 5. Computer system 600 is only one example of a computer system and is not intended to suggest any limitation as to the scope of use or functionality of embodiments of the present disclosure. Regardless, computer system 600 is capable of being implemented to perform and/or performing any of the functionality/operations of the present disclosure.

Computer system 600 includes a computer system/server 612, which is operational with numerous other general purpose or special purpose computing system environments or configurations. Examples of well-known computing systems, environments, and/or configurations that may be suitable for use with computer system/server 612 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer system/server 612 may be described in the general context of computer system-executable instructions, such as program modules, being executed by a computer system. Generally, program modules may include routines, programs, objects, components, logic, and/or data structures that perform particular tasks or implement particular abstract data types. Computer system/server 612 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, the components of computer system/server 612 may include, but are not limited to, one or more processors or processing units 616, a system memory 628, and a bus 618 that couples various system components including system memory 628 to processor 616. The computer system 140 of FIG. 1 may include some or all of the components described with reference to the computer system 600.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 612 typically includes a variety of computer system readable media. Such media may be any available media that is accessible by computer system/server 612, and includes both volatile and non-volatile media, removable and non-removable media.

System memory 628 can include computer system readable media in the form of volatile memory, such as random access memory (RAM) 630 and/or cache memory 632.

Computer system/server 612 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions/operations of embodiments of the disclosure.

Program/utility 640, having a set (at least one) of program modules 642, may be stored in memory 628 by way of example, and not limitation. Exemplary program modules 642 may include an operating system, one or more application programs, other program modules, and program data. Each of the operating system, one or more application programs, other program modules, and program data or some combination thereof, may include an implementation of a networking environment. Program modules 642 generally carry out the functions and/or methodologies of embodiments of the present disclosure.

Computer system/server 612 may also communicate with one or more external devices 614 such as a keyboard, a pointing device, a display 624, one or more devices that enable a user to interact with computer system/server 612, and/or any devices (e.g., network card, modem, etc.) that enable computer system/server 612 to communicate with one or more other computing devices. Such communication can occur via Input/Output (I/O) interfaces 622. Still yet, computer system/server 612 can communicate with one or more networks such as a local area network (LAN), a general wide area network (WAN), and/or a public network (e.g., the Internet) via network adapter 620. As depicted, network adapter 620 communicates with the other components of computer system/server 612 via bus 618. It should be understood that although not shown, other hardware and/or software components could be used in conjunction with computer system/server 612. Examples include, but are not limited to microcode, device drivers, redundant processing units, external disk drive arrays, RAID systems, tape drives, and data archival storage systems.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. An apparatus comprising:
a light source providing light;
a flow cell having a bore for providing a flow path for a fluid sample and for transmitting the light from the light source through the fluid sample in the bore, the bore extending from an input port to a first output port of the flow cell, and for capturing a scattered portion of the light for output through a second output port;
a first detector proximal to the first output port for measuring a transmitted light intensity of the light source;
a second detector proximal to the second output port for measuring a scattered intensity of the light source; and
a special purpose computer processor that calculates a true absorption value from the measured transmitted light intensity and the measured scattered intensity.

2. The apparatus of claim 1, wherein the flow cell is a spherical cell or integrating sphere that has a solid interior and includes a diffuser coating about a spherical surface of the spherical flow cell, and wherein the first and second output ports extend through the diffuser coating so that at least the scattered portion can exit the spherical flow cell.

3. The apparatus of claim 1, wherein the flow cell is a spherical cell or integrating sphere that has a hollow interior and includes a diffuser coating about a spherical surface of the spherical flow cell, and further includes a tubular element extending through the hollow interior for providing the flow path for the fluid sample and the light.

4. The apparatus of claim 1, wherein the second detector includes a scattered light detector optically coupled to an opening in the diffuser coating at the second output port to detect the scattered portion of the light, and for distinguishing the scattered portion of the light from an absorbed portion of the transmitted light intensity in order to determine a true absorption value.

5. The apparatus of claim 4, wherein the special purpose computer processor calculates a molecular concentration of analytes referred to as nanoparticles of the fluid sample from the true absorption value.

6. The apparatus of claim 5, wherein the nanoparticles are greater than 40 nm.

7. The apparatus of claim 5, wherein the nanoparticles have a dimension greater than one tenth of the wavelength of the source of light.

8. The apparatus of claim 1, wherein the sample material is part of a solution that includes a formulation of lipid nanoparticles (LNPs) encapsulating ribonucleic acid (RNA).

9. The apparatus of claim 1, further comprising an inlet window adjacent the input port and an outlet window adjacent the first output port for providing an optical path through the bore for the transmitted light intensity, wherein the inlet window is optically coupled to a light source, and wherein the outlet window is optically coupled to the first detector.

10. The apparatus of claim 1, further comprising one or more wavelength-selective dispersion gratings to provide two or more input wavelengths of light from the light source prior to an array of photodiodes for transmission and scattering.

11. The apparatus of claim 1, wherein a center of the flow cell is at an intersection of a first axis and a second axis perpendicular to the first axis, where the flow path extends along the first axis, and the second detector is offset from the second axis.

12. An apparatus comprising:
an optically transparent sphere, wherein an outer surface of the sphere comprises a diffuser coating to reflect scattered light in multiple directions;
a bore through an axis of the sphere to allow for the flow of an analyte,
wherein the bore is coupled to a fluid inlet, to a fluid outlet, to an inlet window adjacent to the fluid inlet, and to an outlet window adjacent to the fluid outlet,
wherein the inlet window is optically coupled to a light source, and
wherein the outlet window is optically coupled to a transmission detector;
an opening in the diffuser coating and in a flow cell holder housing the sphere,
wherein the opening allows for the scattered light to exit the sphere; and
a scattering detector optically coupled to the opening in the diffuser coating to detect the scattered light, allowing for calculating absorption by the analyte.

13. A computer-implemented method comprising:
providing, by a flow cell, a fluid path for fluid sample constituents;
transmitting light from a source of light through the fluid sample constituents in the fluid path from an input port to a first output port of the flow cell;
capturing, by the flow cell, a scattered portion of the light for output through a second output port of the flow cell;
measuring, by a first detector, a transmitted light intensity of the source of light;
measuring, by a second detector, a scattered intensity of the source of light; and
calculating, by a computer system, a true absorption value from the measured light intensity and the measured scattered intensity.

14. The computer-implemented method of claim 13, wherein the flow cell is a spherical cell or integrating sphere.

15. The method of claim 13, further comprising performing inline analytics to analyze LNP-RNA particles in a formulation, resulting in measurements of physical properties of the LNP-RNA particles.
